(19) United States
(12) Patent Application Publication
(10) Pub. No.: US 2026/0108099 A1
(43) Pub. Date: Apr. 23, 2026

(54) COOKING POT APPARATUS

(71) Applicant: SHANG HAI AICAN ROBOT (GROUP) CO., LTD., Shanghai (CN)

(72) Inventors: Qing HE, Shanghai (CN); Guang HE, Shanghai (CN); Yingzhi YANG, Shanghai (CN); Jian LAI, Shanghai (CN); Honglun PANG, Shanghai (CN)

(21) Appl. No.: 19/423,746

(22) Filed: Dec. 17, 2025

Related U.S. Application Data
(63) Continuation of application No. PCT/CN2024/091636, filed on May 8, 2024.

(30) Foreign Application Priority Data
Jul. 4, 2023 (CN) 202310807894.4

(51) Int. Cl. A47J 36/32; A47J 43/046

(52) U.S. Cl. CPC A47J 36/32; A47J 43/046; A47J 2202/00

(57) ABSTRACT

A cooking pot apparatus comprising a cooking pot, a mounting base installed at the center of the inner bottom surface of the cooking pot, and a stirring blade disposed on the mounting base is provided. A temperature measuring element for real-time detection of the temperature of food ingredients being cooked in the cooking pot is provided inside the cooking pot. The temperature measuring element is disposed on the stirring blade, and its connecting wires pass sequentially through a wire groove provided on the stirring blade, a wire groove on the mounting base, and a central hole at the bottom of the cooking pot, then extend out from a hollow rotating shaft and connect to a control circuit. A temperature measuring probe of the temperature measuring element contacts the food ingredients inside the cooking pot.

### CROSS-REFERENCE TO RELATED APPLICATIONS

This application is a continuation of International Patent Application No. PCT/CN2024/091636 with a filing date of May 8, 2024, designating the United States, now pending, and further claims priority to Chinese Patent Application No. 202310807894.4 with a filing date of Jul. 4, 2023. The content of the aforementioned applications, including any intervening amendments thereto, are incorporated herein by reference.

### TECHNICAL FIELD

The invention relates to the field of cooking equipment, and more specifically, to a cooking pot apparatus in cooking equipment.

### BACKGROUND ART

During the cooking process, the cooking temperature (the set temperature corresponding to the power output controlled by the main control circuit of the cooking machine) is a key factor affecting the taste of cooked dishes, etc. In intelligent cooking processes, accurate control of the cooking temperature relies on accurate temperature feedback information.

In existing cooking pot apparatuses, a heating device arranged around the periphery of the cooking pot heats the cooking pot, which then transfers heat to the food ingredients inside. The temperature information is typically collected by installing a temperature detector on the outer wall of the pan. The main control circuit adjusts the output value of the power board based on the detected pot temperature to change the executed cooking temperature. Or, based on the detected pot temperature, it appropriately compensates the temperature according to previous test experience to estimate the actual temperature of the food ingredients in the pot, and then decides whether to adjust the cooking temperature; or, infrared sensors are arranged above the pan opening to detect the temperature of the food ingredients in the pot.

Such cooking pot apparatuses have the following shortcomings in temperature measurement:
1. The temperature detector installed on the outer wall of the cooking pot only allows detection of the temperature of the outer wall. During cooking, there is often a significant difference between the actual temperature of the food ingredients and the temperature of the outer wall of the pot. Influenced by uncertain factors such as the type of food material (meat, vegetables, or fluids) and its looseness, the temperature of the ingredients, and the ambient temperature, it is impossible to accurately calculate the conductive heat transfer from the pot to the ingredients. In such cases, adjusting the cooking temperature based on the detected outer wall temperature can easily result in the food ingredients not being cooked to the desired doneness and state.
2. Experimentally obtained empirical values as compensation for the temperature difference are generally not reliable because these empirical values cannot cover all possible variables. Therefore, inconsistent results (sometimes undercooked, sometimes overcooked) can occur, failing to ensure the stability of cooked dishes and still unable to accurately control the doneness of ingredients and the cooking effect.
3. When using infrared sensors to detect temperature, they are easily affected by oil fumes and gases, leading to inaccurate temperature readings of the food ingredients detected by the infrared sensor.

### SUMMARY

The technical problem solved by the disclosure is to provide a cooking pot apparatus capable of accurately measuring the temperature of food ingredients within the cooking pot.

To solve the above technical problem, the disclosure provides a cooking pot apparatus. The apparatus includes a cooking pot, a mounting base installed at the center of the inner bottom surface of the cooking pot, and a stirring blade disposed on the mounting base. A temperature measuring element is provided inside the cooking pot for real-time detection of the temperature of the food ingredients being cooked. The temperature measuring element is embedded in the inner wall of the cooking pot, and its connecting wires pass sequentially through wire grooves provided on the inner wall of the cooking pot, a central hole at the bottom of the cooking pot, then extend out from a hollow rotating shaft provided on the outer bottom surface of the cooking pot and connect to a control circuit that controls the cooking process of the cooking pot. Alternatively, the temperature measuring element is disposed on the stirring blade, and its connecting wires pass sequentially through wire grooves provided on the stirring blade, wire grooves on the mounting base, and the central hole, then extend out from the hollow rotating shaft and connect to the control circuit. Alternatively, the temperature measuring element is disposed on the mounting base, and its connecting wires pass sequentially through the wire groove and the central hole, then extend out from the hollow rotating shaft and connect to the control circuit. The temperature measuring probe of the temperature measuring element contacts the food ingredients inside the cooking pot.

Preferably, the temperature measuring probe of the temperature measuring element disposed on the mounting base is embedded in a recess on the mounting base. A sealing structure is provided on the recess to sealably cover it, and the temperature measuring probe is in tight contact with this sealing structure.

Preferably, the root of the stirring blade is fixedly connected to the mounting base, and the body of the stirring blade extends from bottom to top towards the opening of the cooking pot. The temperature measuring element disposed on the stirring blade is installed at the root of the stirring blade.

Preferably, the temperature measuring element is a temperature and humidity sensor.

Preferably, the temperature measuring element is a temperature sensor, and a humidity sensor for detecting the humidity of the food ingredients being cooked in the cooking pot is also provided on the stirring blade.

Preferably, a viscosity sensor for detecting the viscosity of the soup or sauce of the dish being cooked in the cooking pot is also provided on the stirring blade.

By arranging the temperature measuring element inside the cooking pot, the present invention enables the temperature measuring element to directly perform contact temperature measurement with the food ingredients in the pan, allowing accurate detection of the actual temperature of the ingredients and further improving the accuracy of temperature control during the cooking process.

### DESCRIPTION OF THE ACCOMPANYING DRAWINGS

FIG. 1 is a structural schematic diagram of the cooking pot apparatus according to the disclosure.

FIG. 2 is an enlarged view of the portion A in the FIG. 1.

In the drawings: Cooking pot 1, Hollow rotating shaft 11, Temperature measuring element 2, Temperature measuring probe 21, Connecting wire 22, Stove core 3, Inner shell 31, Outer shell 32, Heating assembly 33, Stirring blade 4, Mounting base 5.

### BEST MODE FOR CARRYING OUT THE INVENTION

The disclosure directly places the temperature measuring element 2 inside the cooking pot 1 of the cooking pot apparatus, allowing the temperature measuring element 2 to directly contact the food ingredients for temperature measurement, thereby accurately detecting the actual temperature of the ingredients and further improving the accuracy of temperature control during the cooking process.

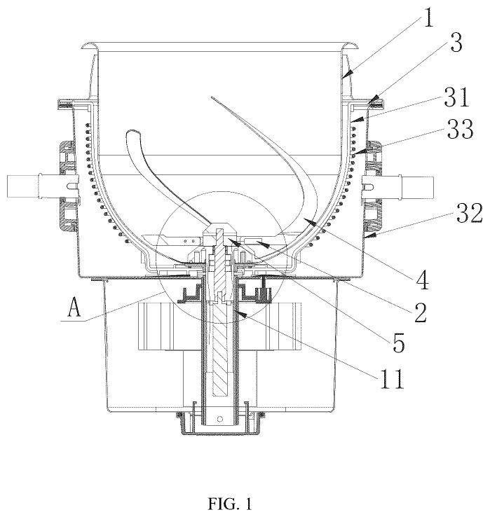

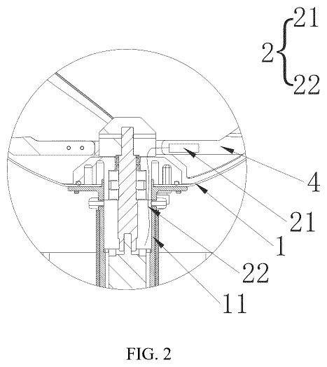

As shown in FIGS. 1-2, the cooking pot apparatus includes a cooking pot 1, a temperature measuring element 2 for detecting the temperature of the food ingredients inside the cooking pot 1, and a stove core 3 for heating the cooking pot 1. The disclosure preferably includes a mounting base 5 provided at the center of the inner bottom surface inside the cooking pot 1, and a stirring blade 4 provided on the mounting base 5.

### 1. Cooking Pot 1

The cooking pot 1 has an opening at the top, an upper part (taking the orientation of the cooking pot apparatus on the paper in FIG. 1 as reference, the opening direction is up, and the opposite direction is down, the same below) is cylindrical, a lower part is an arc-shaped body, and the bottom surface is flat.

A mounting base 5 is provided at the center of the inner surface of the bottom of the cooking pot 1. Preferably, the vertical cross-sectional shape of the mounting base 5 is square in the lower part and trapezoidal in the upper part. A hollow rotating shaft 11 coaxial with the cooking pot 1 is fixedly connected to the outer surface of the bottom of the cooking pot 1. A central hole coaxial with the hollow rotating shaft 11 is provided in the bottom of the cooking pot 1, and the diameter of the central hole is smaller than the inner diameter of the axial passage. A vertical motor is fixedly installed inside the hollow rotating shaft 11. The drive shaft of the vertical motor passes through the central hole into the cooking pot 1 and is fixedly connected to the mounting base 5.

The root of the stirring blade 4 is fixedly connected to the mounting base 5. The body of the stirring blade 4 extends from the bottom upwards towards the opening of the cooking pot 1. The vertical motor drives the mounting base 5 to rotate, thereby causing the stirring blade 4 to rotate relative to the cooking pot 1 to stir the food ingredients inside the cooking pot 1.

### 2. Stove Core 3

The stove core 3 includes an inner shell 31, a heating assembly 33, and an outer shell 32. The inner shell 31 has an opening on the top, a flat bottom, and a vertical cross-sectional shape that is curved. This curved shape is the same as the curved shape of the vertical cross-section of the lower half of the cooking pot 1. The cooking pot 1 is coaxially arranged within the cavity enclosed by the inner shell 31. The heating assembly 33 is an electromagnetic heating coil wound around the outer wall of the inner shell 31.

The outer shell 32 encloses the outside of the heating assembly 33, serving to protect the heating assembly 33 from water and oil stains. Preferably, the outer shell 32 is made of metal material. The outer shell 32 includes a side wall and a bottom plate. The side wall and the bottom plate form a cylindrical structure. The inner shell 31, together with the electromagnetic heating coil, is accommodated within the outer shell 32. The opening edge of the inner shell 31 is fixedly connected to the top opening edge of the outer shell 32, and the bottom surface of the inner shell 31 rests on the upper surface of the bottom plate.

Central through-holes are provided in both the bottom of the inner shell 31 and the bottom plate of the outer shell 32. The lower end of the hollow rotating shaft 11 passes through these two central through-holes and extends below the bottom plate. A drive component for supporting the cooking pot 1 and enabling relative rotational movement between the cooking pot 1 and the inner shell 31 is provided below the bottom plate. The outer walls on both sides of the outer shell 32 are connected to the frame of the cooking machine via a swinging mechanism.

### 3. Temperature Measuring Element 2

The temperature measuring element 2 for real-time temperature detection of the food ingredients being cooked inside the cooking pot 1 is provided within the cooking pot 1. The temperature measuring probe 21 of the temperature measuring element 2 contacts the food ingredients inside the cooking pot 1. The connecting wires 22 (including power supply wires and signal wires) of the temperature measuring element 2 are led out through the hollow rotating shaft 11 and electrically connected to an external control circuit that controls the cooking process of the cooking pot 1. Specifically, the installation methods of the temperature measuring element 2 mainly include the following three types:

1) The temperature measuring element 2 is embedded in the inner wall of the cooking pot 1.

Preferably, the temperature measuring element 2 is located in the lower region of the cooking pot 1. One end of its temperature measuring probe 21, with the connecting wires 22, is fixed to the inner wall of the cooking pot 1, and the other end extends away from the inner wall into the inner cavity of the cooking pot 1.

This installation method extends the temperature measuring probe 21 into the inner cavity of the cooking pot 1, allowing the probe 21 to fully contact the food ingredients, which is beneficial for temperature collection.

Alternatively, the temperature measuring probe 21 is partially embedded in a groove (the groove can be a tiny cavity just accommodating the temperature measuring probe 21) on the inner wall of the cooking pot 1 in a lying-flat manner. A heat insulation sheet is provided between the temperature measuring probe 21 and the groove.

This installation method is relatively stable in structure, which is beneficial for the service life of the temperature measuring probe 21.

The connecting wires 22 pass sequentially through a wire groove provided on the inner wall of the cooking pot 1, the central hole at the bottom of the cooking pot 1, then extend out from the hollow rotating shaft 11 provided at the bottom of the cooking pot 1 and connect to the control circuit.

The number of the temperature measuring element(s) 2 can be one or multiple. By arranging multiple temperature measuring elements 2 at different positions, the temperatures of ingredients at different locations can be detected, making the temperature detection value more accurate.

2) The temperature measuring element 2 is disposed on the stirring blade 4.

When the temperature measuring element 2 is disposed on the stirring blade 4, its temperature measuring probe 21 can also be installed by having one end fixed and the other end extending away from the stirring blade 4 into the inner cavity of the cooking pot 1. Alternatively, the temperature measuring probe 21 lies flat on the stirring blade 4 with part of it embedded in the stirring blade 4. Its connecting wires 22 pass sequentially through a wire groove provided on the stirring blade 4, the wire groove on the mounting base 5, and the central hole, then extend out from the hollow rotating shaft 11 and connect to the control circuit.

When the stirring blade 4 stirs the ingredients, it is surrounded by them. Installing the temperature measuring element 2 on the stirring blade 4 allows detection of the internal temperature of the ingredients. Furthermore, as the stirring blade 4 rotates, the temperature measuring element 2 can measure the temperature of ingredients at different positions, making the temperature collection more comprehensive, while also saving costs.

Preferably, the temperature measuring probe 21 is disposed at the root of the stirring blade 4.

The root of the stirring blade 4 is the position closest to the bottom of the cooking pot 1. When cooking a small amount of ingredients, the ingredients only accumulate in the bottom area of the cooking pot 1. Setting the temperature measuring probe 21 too high may cause failure to detect the temperature of ingredients piled at the bottom. Placing the temperature measuring probe 21 at this position accommodates temperature detection for different amounts of ingredients.

3) The temperature measuring element 2 is disposed on the mounting base 5.

A recess is provided on the mounting base 5. The temperature measuring probe 21 of the temperature measuring element 2 is embedded in this recess. A heat insulation pad is provided between the temperature measuring probe 21 and the recess.

Furthermore, to prevent soup or juice from flowing into the recess, a sealing structure is provided on the recess to sealably cover it. The sealing structure can be made of a material with high thermal conductivity. The temperature measuring probe 21 is in tight contact with this sealing structure.

The connecting wires 22 of the temperature measuring element 2 pass sequentially through the wire groove on the mounting base 5 and the central hole, then extend out from the hollow rotating shaft 11 and connect to the control circuit.

The disclosure can also include the temperature measuring element 2 at two or all three of the following positions simultaneously: the wall of the cooking pot 1, the stirring blade 4, and the mounting base 5.

The temperature measuring element 2 can be a temperature and humidity sensor, which can detect the temperature of the food ingredients in the cooking pot 1 and also the humidity of the ingredients.

The temperature measuring element 2 can also be a single-function temperature sensor, and a humidity sensor for detecting the humidity of the food ingredients being cooked in the cooking pot 1 is additionally provided on the stirring blade 4.

By adding a humidity sensor on the stirring blade 4, the cooking pot apparatus can detect the temperature of the ingredients inside the cooking pot 1 while also collecting the overall humidity of the ingredients. This facilitates the control circuit in controlling the moisture content of the ingredients during cooking, especially when high heat (high temperature) is needed to reduce the sauce. The information detected by the humidity sensor provides the most intuitive information for the control system, which is more conducive to the overall outcome of the cooked dish.

Further, a viscosity sensor for detecting the viscosity of the soup or sauce of the dish being cooked in the cooking pot 1 can also be provided on the stirring blade 4 to further enhance the cooking performance of the cooking pot apparatus.

What is claimed is:

1. A cooking pot apparatus, comprising a cooking pot (1), a mounting base (5) installed at the center of the inner bottom surface of the cooking pot (1), and a stirring blade (4) disposed on the mounting base (5); wherein a temperature measuring element (2) for real-time detection of the temperature of food ingredients being cooked in the cooking pot (1) is provided inside the cooking pot (1); the temperature measuring element (2) is arranged on the mounting base (5), and connecting wires (22) of the temperature measuring element (2) pass sequentially through a wire channel on the mounting base (5) and a central hole at the bottom of the cooking pot (1), then extends out from a hollow rotating shaft (11) provided on the outer bottom surface of the cooking pot (1), and is connected to a control circuit for controlling cooking processes of the cooking pot (1); and a temperature measuring probe (21) of the temperature measuring element (2) is in contact with the food ingredients inside the cooking pot (1).

2. The cooking pot apparatus of claim 1, wherein the temperature measuring element (2) is embedded in the inner wall of the cooking pot (1); the connecting wires (22) pass sequentially through a wire groove provided on the inner wall of the cooking pot (1) and the central hole, then extends out from the hollow rotating shaft (11) and is connected to the control circuit.

3. The cooking pot apparatus of claim 2, wherein the temperature measuring element (2) is provided on the stirring blade (4); the connecting wires (22) pass sequentially through a wiring groove provided on the stirring blade (4), the wire channel, and the central hole, then extends out from the hollow rotating shaft (11) and is connected to the control circuit.

4. The cooking pot apparatus of claim 1, wherein the temperature sensing probe (21) is embedded in a recess provided on the mounting base (5); a sealing structure is arranged on the recess to sealably cover the recess, and the temperature sensing probe (21) is in tight contact with the sealing structure.

5. The cooking pot apparatus of claim 3, wherein the root of the stirring blade (4) is fixedly connected to the mounting base (5); a blade body of the stirring blade (4) extends from bottom to top toward the opening of the cooking pot (1); and the temperature measuring element (2) provided on the stirring blade (4) is installed at the root of the stirring blade (4).

6. The cooking pot apparatus of claim 5, wherein the temperature measuring element (2) is a temperature and humidity sensor.

7. The cooking pot apparatus of claim 5, wherein the temperature measuring element (2) is a temperature sensor, and a humidity sensor for detecting the humidity of the food ingredients being cooked in the cooking pot (1) is also provided on the stirring blade (4).

8. The cooking pot apparatus of claim 7, wherein a viscosity sensor for detecting the viscosity of the soup or sauce of the dish being cooked in the cooking pot (1) is also provided on the stirring blade (4).
